(19) United States
(12) Patent Application Publication
(10) Pub. No.: US 2009/0193358 A1
(43) Pub. Date: Jul. 30, 2009

(54) METHOD AND APPARATUS FOR FACILITATING INFORMATION ACCESS DURING A MODAL OPERATION

(75) Inventors: Paul A. Mernyk, Palo Alto, CA (US); Dawn Hughan, San Jose, CA (US); Wendy Castleman, San Jose, CA (US); Michael Stephen Posner, Alpharetta, GA (US); Greg Macdonald, Mountain View, CA (US); Abhinav Nittal, Sunnyvale, CA (US)

Correspondence Address: PVF -- INTUIT, INC.;c/o PARK, VAUGHAN & FLEMING LLP, 2820 FIFTH STREET, DAVIS, CA, 95618-7759, US

(73) Assignee: Intuit Inc., Mountain View, CA (US)

(21) Appl. No.: 12/022,852

(22) Filed: Jan. 30, 2008

(51) Int. Cl. G06F 3/048

(52) U.S. Cl. 715/804

(57) ABSTRACT

One embodiment of the present invention provides a system that facilitates accessing information during a modal operation. The system operates by presenting an initial window for an application to a user in a display. The system then presents a subsequent window in the display for another function related to the application. During this process, the system presents these two windows in proximity to each other, and ensures that this proximity is maintained, even across user changes to one or both windows. At a later point, during operation, the system receives an input from the user that results in a modal operation for the application that restricts user changes to and/or user control of the initial window during the modal operation. Despite this modal operation, the system remains able to receive a subsequent input for the subsequent window from the user and, in response, update information displayed in the subsequent window during the modal operation. This allows the user to continue to access application information despite the modal operation.

### BACKGROUND

User interface designers strive to make computer applications intuitive to use and to generally improve the general user experience. The process of creating a user interface for a given computer application generally involves a number of steps, including: gathering user requirements and input; designing and prototyping one or more graphical interfaces and types of interaction; and extensive usability testing. Developing a user interface that anticipates user needs and facilitates user productivity can involve significant effort and expense.

A modal window is a common type of cross-platform user interface that is used to gather essential user input or to draw user attention to a given task or warning. Modal windows are often displayed as separate windows that appear in front of a given application window, and restrict user changes and/or user control of the application window until a requested operation or acknowledgement has been completed in the given modal window. For instance, a system may display a modal window to confirm that a user wishes to execute an irreversible operation, or to solicit user input that is required before a given operation can proceed.

An unfortunate effect of modality is that a modal window may block user access to an application window during a modal operation. For instance, a user who is presented with several choices in a modal window may wish to access help functionality in the associated application to aid in the selection process. However, the user may be blocked from accessing such help functionality by the functional characteristics of the modal window. Some of these restrictive modal characteristics can be avoided, but often only at the cost of substantial additional programming effort.

### SUMMARY

One embodiment of the present invention provides a system that facilitates accessing information during a modal operation. The system operates by presenting an initial window for an application to a user in a display. The system then presents a subsequent window in the display for another function related to the application. During this process, the system presents these two windows in proximity to each other, and ensures that this proximity is maintained, even across user changes to one or both windows. At a later point, the system receives an input from the user that results in a modal operation for the application which restricts user changes to and/or user control of the initial window during the modal operation. Despite this modal operation, the system remains able to receive a subsequent input for the subsequent window from the user and, in response, can update information displayed in the subsequent window during the modal operation. This allows the user to continue to access application information despite the modal operation.

In some embodiments, the subsequent window provides help functionality for the application.

In some embodiments, the system presents the subsequent window in response to a user request received during a modal operation.

In some embodiments, the system maintains the initial window and the subsequent window in proximity to present an appearance that the subsequent window and the initial window are tightly integrated. For instance, the system can ensure that a tightly-integrated subsequent window takes on behavior substantially similar to that of an internal pane, e.g. moving and resizing in conjunction with the initial window. Such an appearance facilitates providing help functionality for an application that remains accessible during a modal operation for the application.

In some embodiments, the initial window and the subsequent window are associated with separate operating system processes. These separate operating system processes exchange window layout information and event notifications user inter-process communication techniques.

In some embodiments, the application governs control of window layout and window updates for both the initial window and the subsequent window.

In some embodiments, the system keeps the initial window and the subsequent window in proximity across user changes that include: resizing one or both of the initial window and the subsequent window; maximizing the size of the initial window and/or the subsequent window; and/or minimizing and/or restoring the initial window and/or the subsequent window.

### BRIEF DESCRIPTION OF THE FIGURES

FIG. 1 illustrates an exemplary application window in accordance with an embodiment of the present invention.

FIG. 2A illustrates a help pane that displays help functionality for a sample application.

FIG. 2B illustrates typical modal behavior for an application window.

FIG. 3A illustrates using a second window to present help functionality for a sample application in accordance with an embodiment of the present invention.

FIG. 3B illustrates a user-initiated window move in accordance with an embodiment of the present invention.

FIG. 3C illustrates the outcome of a user-initiated window move.

FIG. 3D illustrates a modal operation.

FIG. 4A illustrates two windows that remain in proximity across a window move operation in accordance with an embodiment of the present invention.

FIG. 4B illustrates two windows that remain in proximity after a window move operation in accordance with an embodiment of the present invention.

FIG. 5A illustrates two windows in proximity that remain in proximity and in proportion across a window resize operation in accordance with an embodiment of the present invention.

FIG. 5B illustrates two windows that remain in proximity after a window resize operation in accordance with an embodiment of the present invention.

FIG. 6A illustrates an alternate resize operation that re-proportions space between two windows in proximity in accordance with an embodiment of the present invention.

FIG. 6B illustrates the outcome of an alternate resize operation that re-proportions space between two windows in proximity in accordance with an embodiment of the present invention.

FIG. 7A illustrates the outcome of a modified maximize operation for two windows in proximity in accordance with an embodiment of the present invention.

FIG. 7B illustrates a proportional resize operation for two maximized windows in proximity in accordance with an embodiment of the present invention.

FIG. 7C illustrates the outcome of a proportional resize operation for two maximized windows in proximity in accordance with an embodiment of the present invention.

FIG. 8 presents a flow chart illustrating the process of facilitating information access during a modal operation in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

### Challenges of Modality

Computing devices often present one or more “windows” to a user on a graphical display. Such windows can be used to convey information to users and to present a user interface by which users can interact with computer applications.

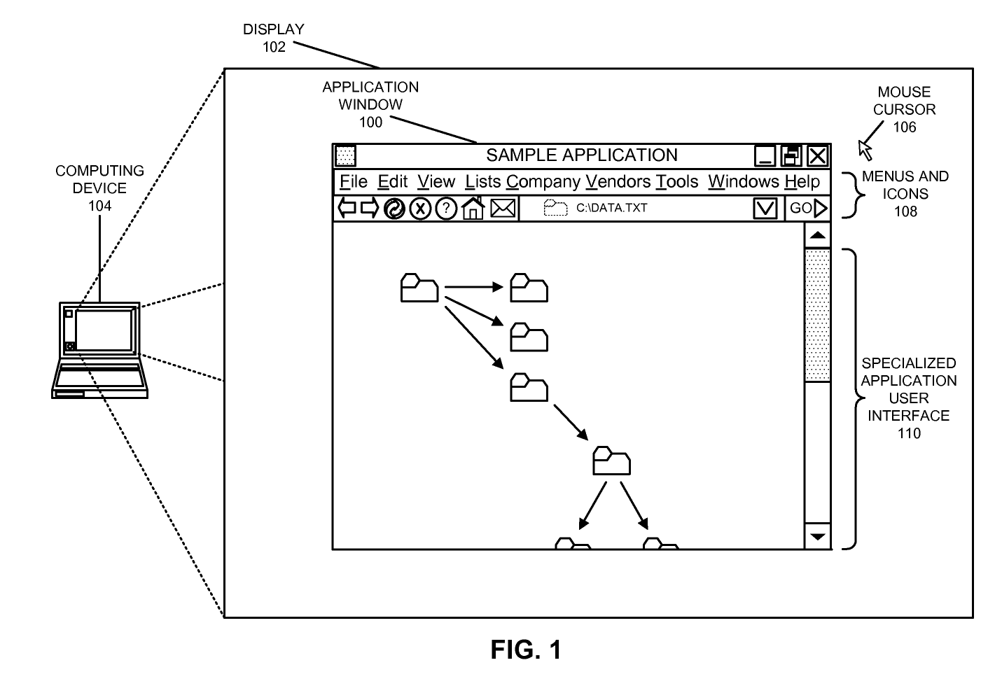

FIG. 1 illustrates an exemplary application window 100 that is presented on display 102 of computing device 104. During operation, a user can use a variety of input methods, such as mouse cursor 106, to control the operation of the application (in FIG. 1, application “Sample Application”). For instance, the user may move mouse cursor 106 to select and click on a variety of menus and icons 108, or to interact directly with a specialized application user interface 110 presented by the application.

During operation, a given application may open multiple windows, or split one or more application windows into distinct panes that convey different data representations and/or functionality. For instance, upon user request, help functionality for an application may be presented in a separate help window or in a pane of an existing application window.

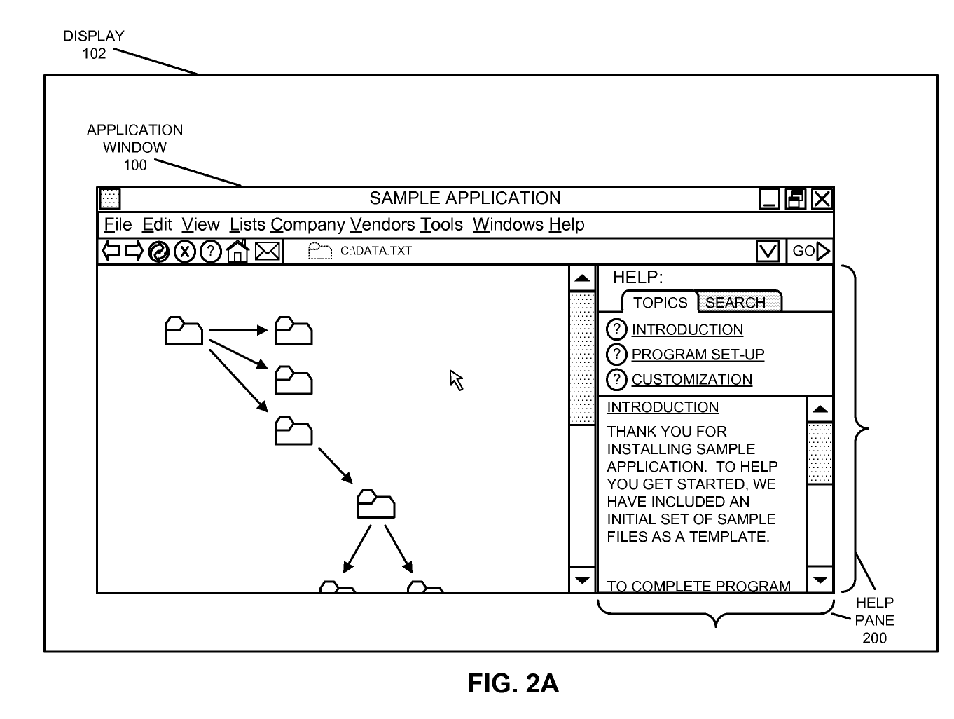

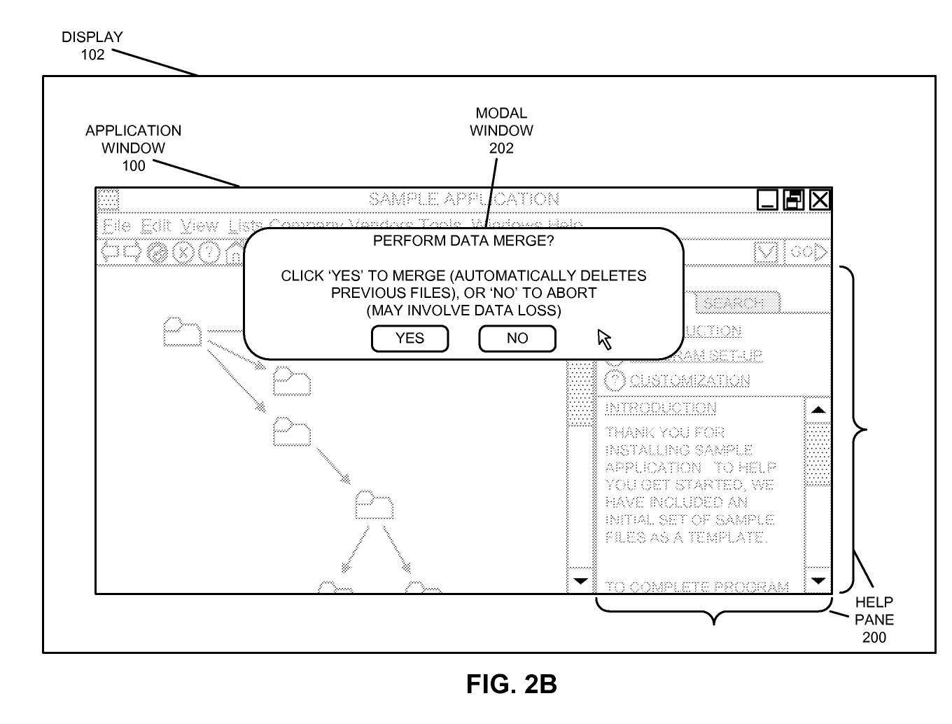

FIG. 2A illustrates a help pane 200 that displays help functionality for the sample application. Help pane 200 is integrated into application window 100.

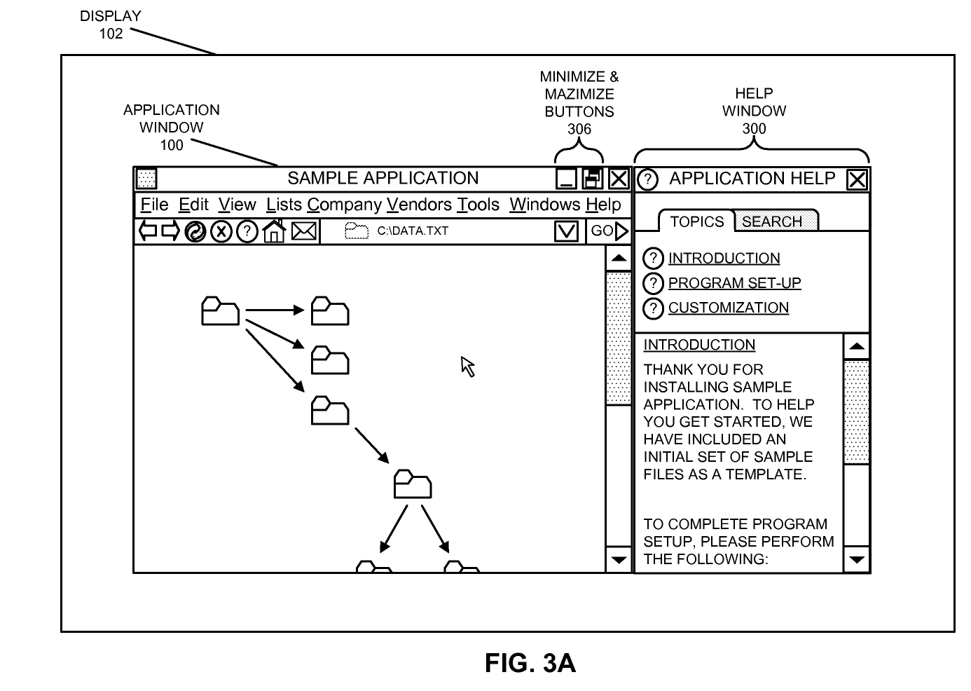

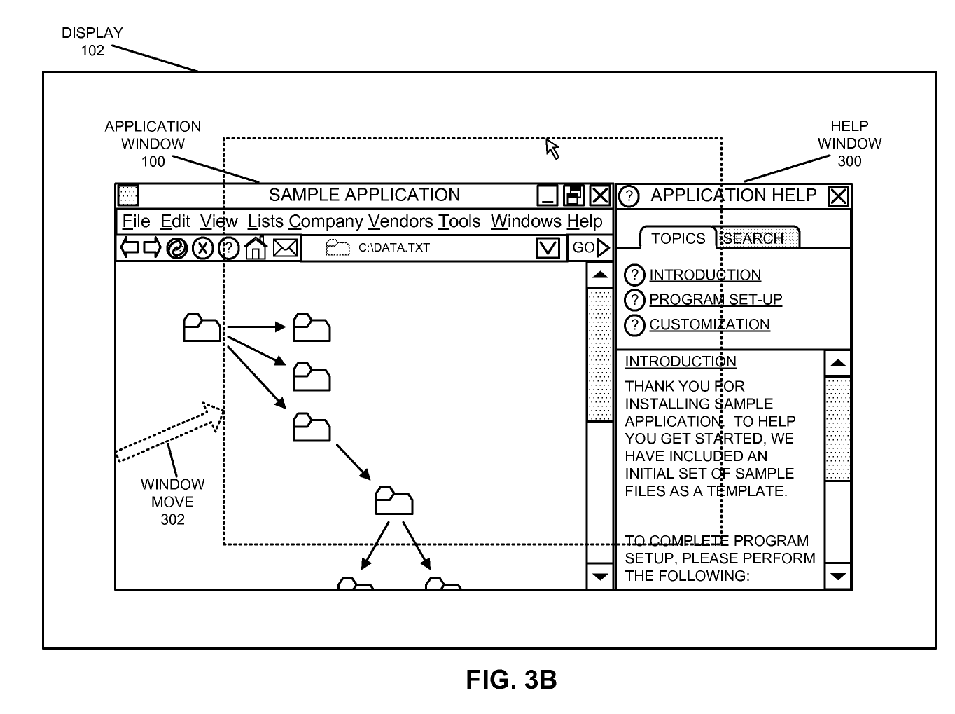

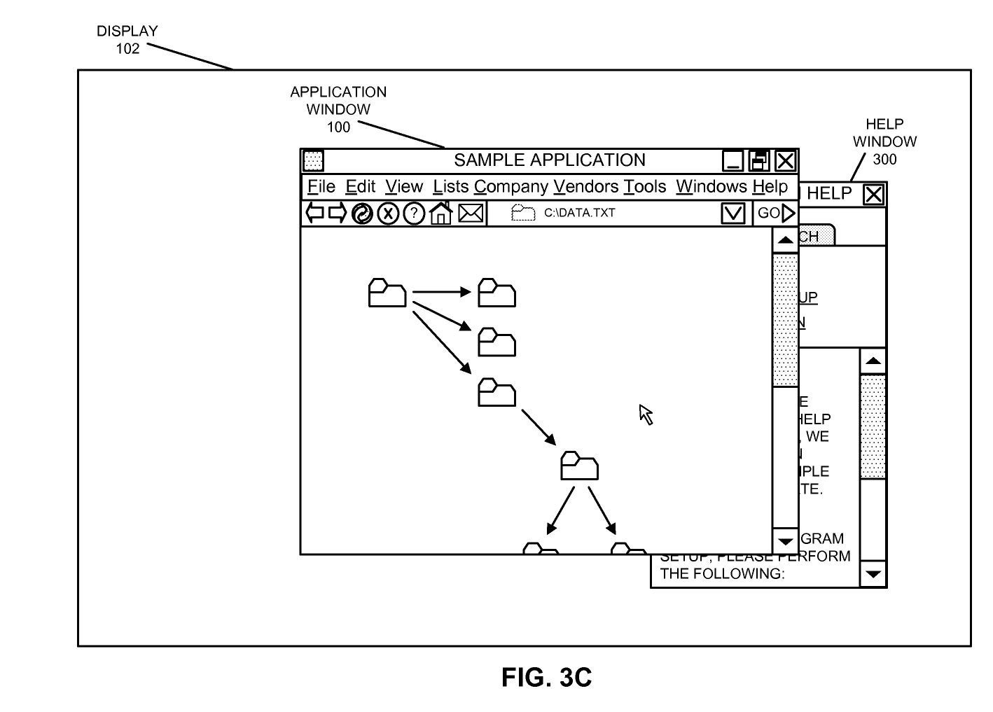

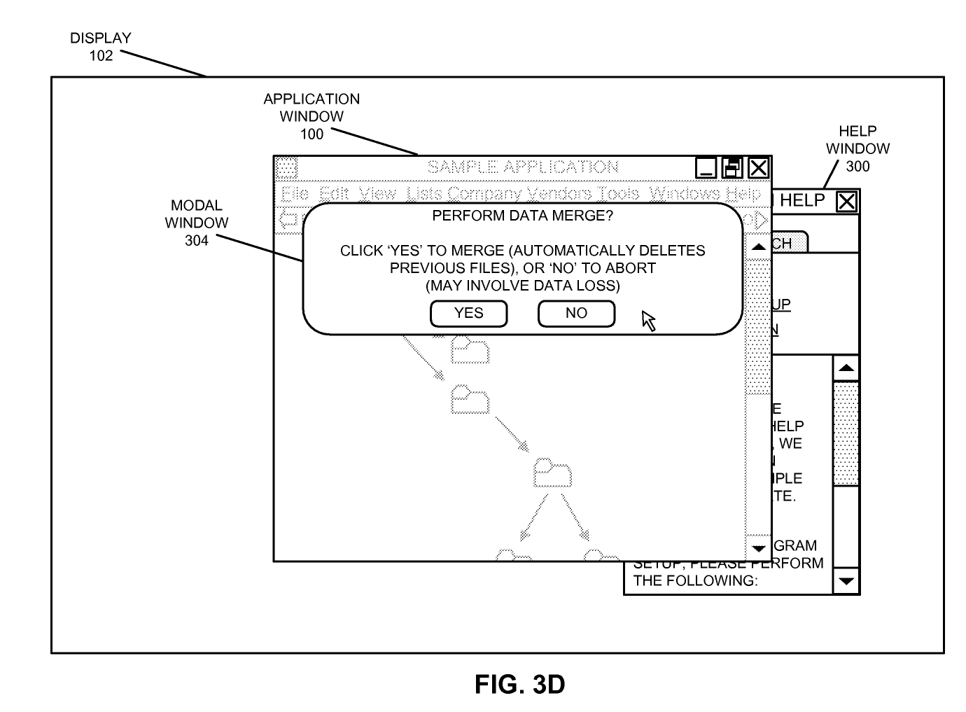

Alternatively, FIG. 3A illustrates using a second window, help window 300, to present help functionality for the sample application.

Unfortunately, the use of additional windows or additional panes in an existing window can both cause difficulties for users during a modal operation, due in part to restrictions in user changes and/or user control of the application window during the modal operation. Typically, the system disables all interaction in an application window when a modal window is present. For instance, FIG. 2B illustrates typical modal behavior for application window 100, which has much of its functionality “grayed out” (or disabled) during the presentation of modal window 202 (sometimes also referred to as a “modal dialog window”.) Hence, a user cannot access, scroll through, or otherwise interact with the help functionality in help pane 200 while modal window 202 is open, which can result in user uncertainty, frustration, and errors, especially when a user attempts to consult the help functionality to access information relating to the modal operation.

Presenting a second, separate window can avoid some of the above-described problems, thereby ensuring that help functionality is not disabled during a modal operation. However, the use of a second window can also present challenges to users. For instance, while a separate help window (such as help window 300 in FIG. 3A) may initially be “docked” in proximity to an associated application window 100, subsequent user actions may result in one of the two windows covering and hence obscuring the other window.

FIG. 3B illustrates a user-initiated window move 302 of application window 100 that results in application window 100 partially obscuring help window 300, as shown in FIG. 3C. The independent nature of the two windows can result in one window partially or completely obscuring the other window, which can cause user confusion during a subsequent modal operation, such as the display of modal window 304 (shown in FIG. 3D). For instance, if help window 300 becomes completely covered by application window 100 during a modal operation, a user might have difficulty accessing help functionality that he/she needs to determine how to respond to modal window 304. Alternatively, help window 300 may also cover up what the user is trying to accomplish within application window 100.

In one embodiment of the present invention, the system tightly-integrates the management of two related windows to ensure that they remain in proximity across user changes, thereby ensuring that a related window remains visible and accessible even when its partner window is engaged in a modal operation.

### Tightly-Integrated Window Management

FIG. 3A illustrates a second window (help window 300) that is displayed in side-by-side proximity with application window 100.

In one embodiment of the present invention, the system facilitates tightly-integrated communication between two (or more) operating system processes controlling two windows. The system ensures that the two windows remain in close proximity to one another across user changes. Furthermore, the system ensures that one of the windows can continue to provide functionality to a user even when the other window is disabled during a modal operation. Note that this technique is not limited to help windows, but can be applied generally to any two or more related windows that are used together in a complementary manner. Note also that the same technique can be applied to two windows managed by a single operating system process, if the process allows one window to be accessed while a second managed window is disabled by a modal operation.

In one embodiment of the present invention, the operating system processes managing the two windows communicate directly via inter-process communication. This communication enables the processes to exchange update information and make adjustments to ensure that the windows remain in proximity to one another over time. Note that the inter-process communication may be achieved using a wide range of techniques, e.g., via the Component Object Model (COM), Remote Procedure Call (RPC), the .NET Framework, etc. Note also that the program code used to create, display, and/or control a window may be implemented using a range of different programming languages and/or runtime environments, and that the two windows and/or processes may be implemented using a mix of such different tools and/or techniques.

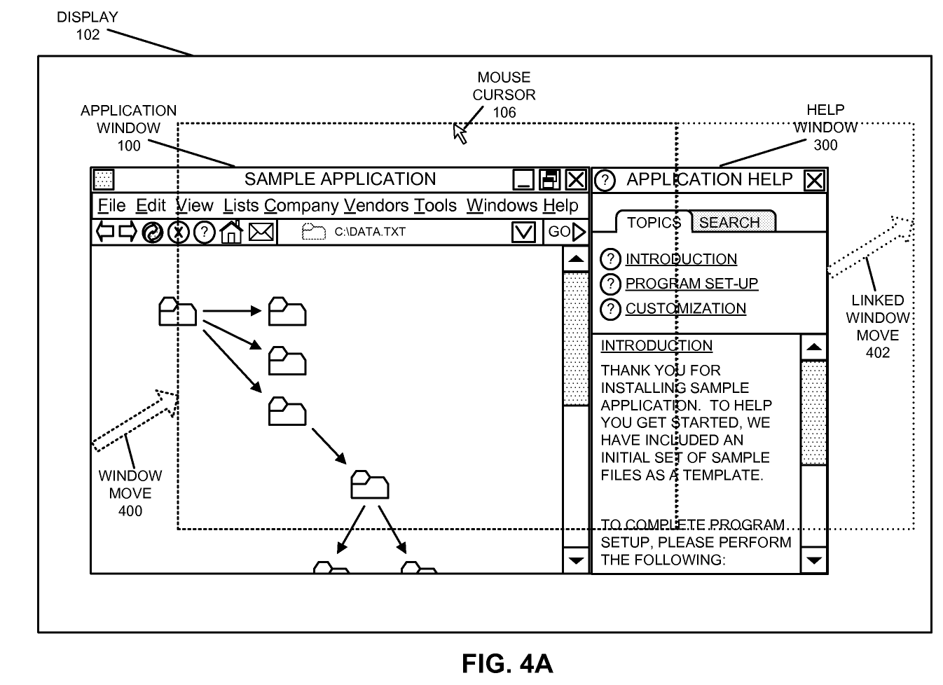

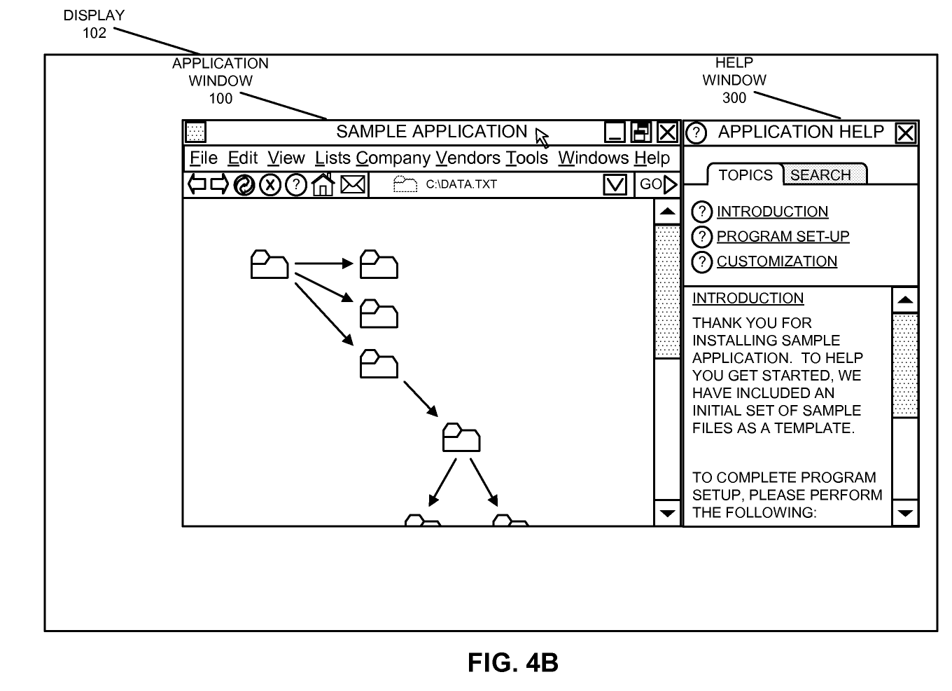

FIG. 4A illustrates two windows that remain in side-by-side proximity across a window move operation 400. For instance, when a user selects application window 100 using mouse cursor 106 and drags the window to another location in display 102, the system detects the change in location and triggers a linked window move operation 402 for help window 300. Hence, the system ensures that help window 300 remains in side-by-side proximity with application window 100, as shown in FIG. 4B.

Note that in some embodiments, the two windows are presented in different levels of proximity. For instance, in one embodiment, the system presents the two windows such that the edges of the two windows are directly joined together, with little or no intervening space. Alternatively, the system may present two related windows in looser proximity, with intervening buffer space.

Note also that in some embodiments, help window 300 moves in parallel (in real-time), as the user moves application window 100. Moving the windows together in real-time conveys to the user that the two windows are linked. Alternatively, in some embodiments the system may move help window 300 after the user has completed the move of application window 100. Note also that the linked window behavior can be bidirectional, with a user move of help window 300 similarly triggering a linked move for application window 100.

In some embodiments of the present invention, linked window behavior may be: managed in entirety by an operating system process that manages one or both of the two respective windows; cooperatively shared between two or more operating system processes that manage the two respective windows; and/or managed by a separate, third application and/or process. Typically, user actions for a window are updated in real-time during each given user action. Now, in addition, the system detects changes for a given window and notifies the managing entity of these changes, so that the managing entity can make corresponding changes in the associated window that was not the originator of the event.

For instance, the entity managing application window 100 (in FIG. 4A) may track geometry and layout information for both application window 100 and help window 300, and receive update information for both windows (either directly or via inter-process communication). When a change is detected in either window, the system can check a set of window constraints to ensure that the linked changes will avoid any window geometry violations, and then trigger a set of linked updates. For instance, the process may check window size constraints to limit window size changes based on the display resolution of display and/or to preserve a minimum window size. Note that application users may not notice or care about how such linked behavior is implemented or controlled, as long as both windows remain in proximity and the desired functionality remains accessible during modal operations.

During operation, one window may be considered “dominant,” and another “subsidiary,” with corresponding special behavior. For example, for application window 100 and help window 300 of FIG. 3A, application window 100 may considered dominant. In this example, when a user closes application window 100, the system may be configured to automatically also close help window 300. Similarly, the system may be configured to minimize help window 300 when application window 100 is minimized, and only display a single minimized icon that represents and/or can be used to restore both minimized windows. Similar actions might not apply in the opposite direction in response to direct actions on the subsidiary window. For instance, closing help window 300 may not result in the closing of primary application window 100. The subsidiary window may also not include some capabilities or options typically found in the dominant window, such as maximize and minimize buttons 306 (in the window title bar). Alternatively, the two windows may share dominant roles cooperatively, or change roles during operation depending on modes in the underlying application.

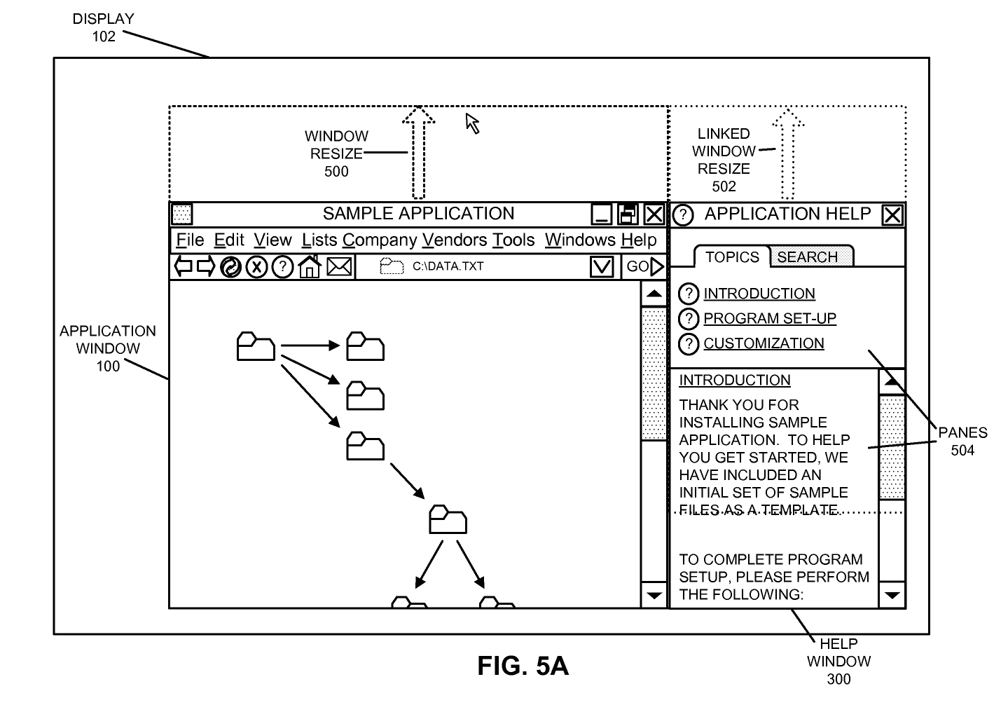

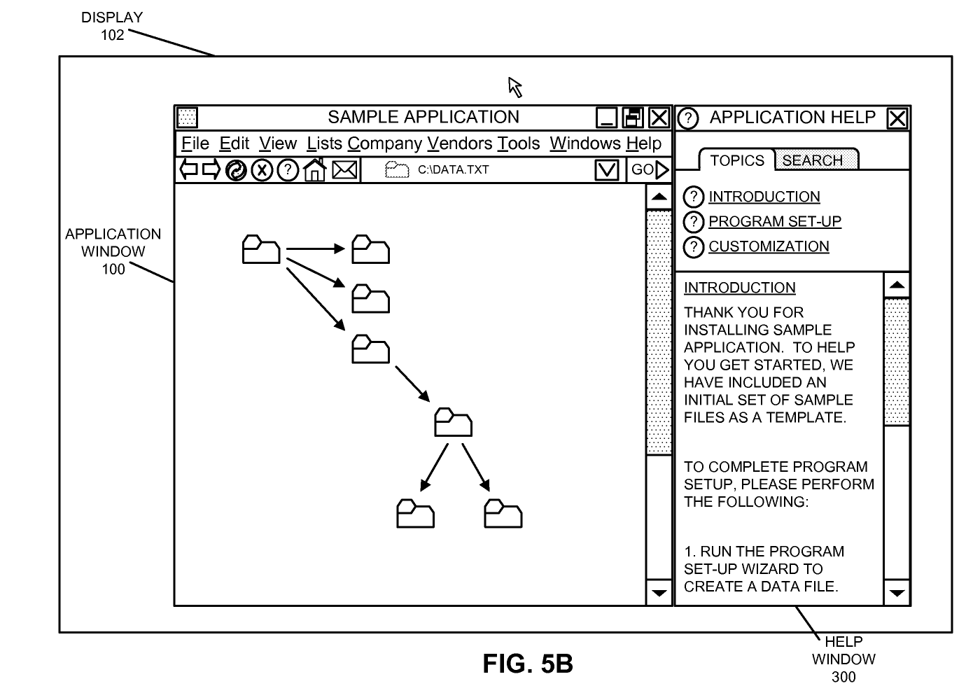

FIG. 5A illustrates two windows that remain in proximity and in proportion to one another across a window resize operation 500. As a user resizes application window 100, the system detects the changes and ensures that help window 300 undergoes a corresponding linked window resize 502, with the resulting resized windows illustrated in FIG. 5B. As described previously for window moves, the system can be configured so that resize operations are bidirectional, with the opposite action of a user resizing of help window 300 similarly resulting in a corresponding resize of application window 100. A developer may specify that during such resize operations two linked windows resize to maintain the same height and/or width as the shared window edge between the two windows.

Note, however, that during a modal operation, a window may be disabled, and hence the user and/or the system may not be able to perform a resize, move, or other window-related operation for the disabled window. In such a scenario, user changes to the non-blocked window may also be blocked. For instance, if an application window is disabled during a modal operation, a user may be restricted from resizing, moving, and/or closing a linked window until the modal operation has completed, in order to prevent the loss of shared window proportions and/or window proximity. However, a user can continue to interact normally with the content inside the boundary of the (enabled) linked window. Furthermore, the linked window may still continue to receive updates relating to operations in the associated window and its modal operation. For instance, in the preceding examples, help window 300 may continue to receive prompts to display help functionality relating to a facet of an ongoing modal operation for application window 100.

Note that one or both windows may include additional internal panes (e.g., panes 504 for help window 300 in FIG. 5A). Such panes 504 may adjust in size during resize operations according to developer specifications. Note also that while help window 300 is shown as a subsidiary window located to the right of dominant application window 100 (e.g., in FIGS. 4A-7), help window 300 can also be located to the left of dominant application window 100, as well as above or below application window 100. Alternatively, two or more linked windows may simultaneously be presented on one or more sides of application window 100.

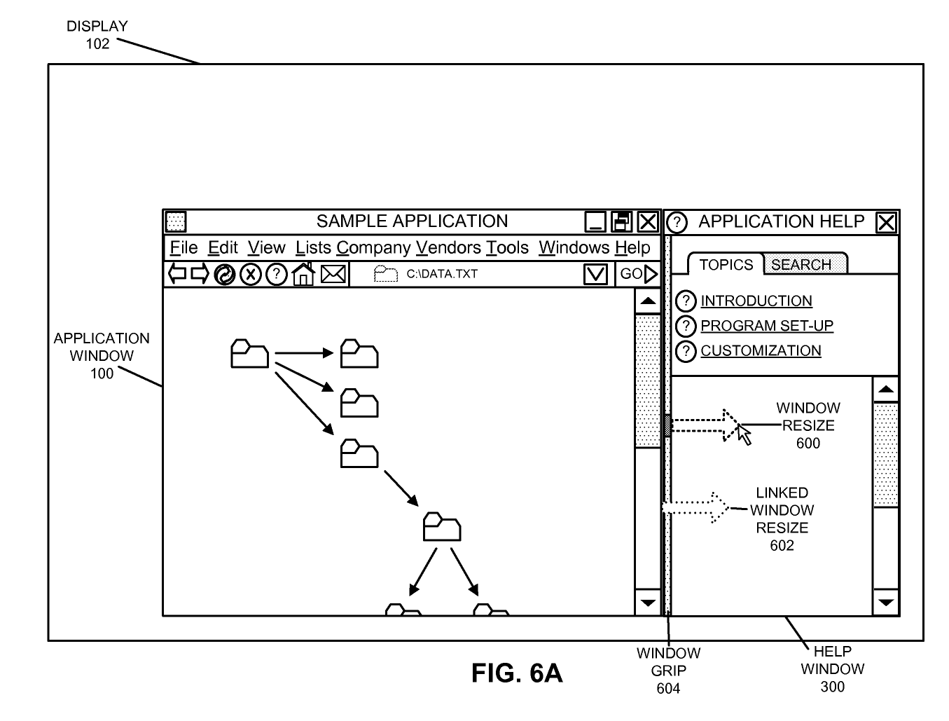

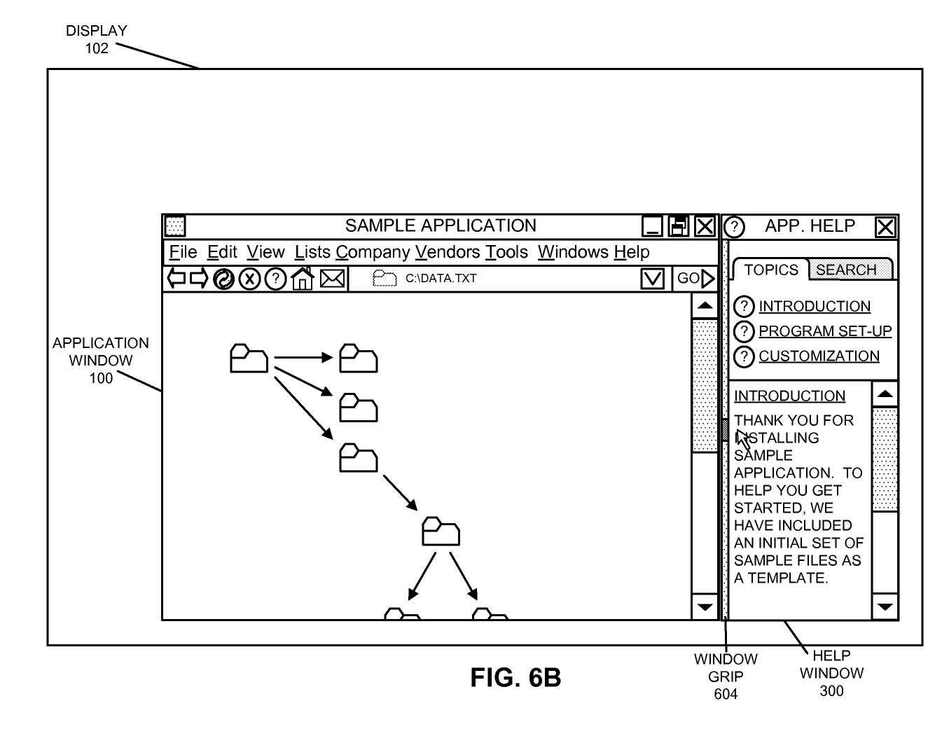

FIG. 6A illustrates an alternate resize operation that re-proportions space between two linked windows. A user can select the left border of help window 300 or the right border of application window 100 using the mouse cursor, and then move the mouse cursor left or right to re-proportion space between the two windows by effectively moving the location of the border between the two windows. For instance, if the user “grabs” the left edge of help window 300 and drags the edge to the right in a window resize operation 600, the right edge of application window 100 moves to follow in a linked window resize operation 602. A user interface designer may include a “window grip” region 604 in one or both windows to signal to users that the windows can be adjusted in this manner. The system can be configured to display and/or hide such window grips during operations (e.g., modal operations) to indicate whether such operations are presently available. FIG. 6B illustrates the result of the described alternate resize operation.

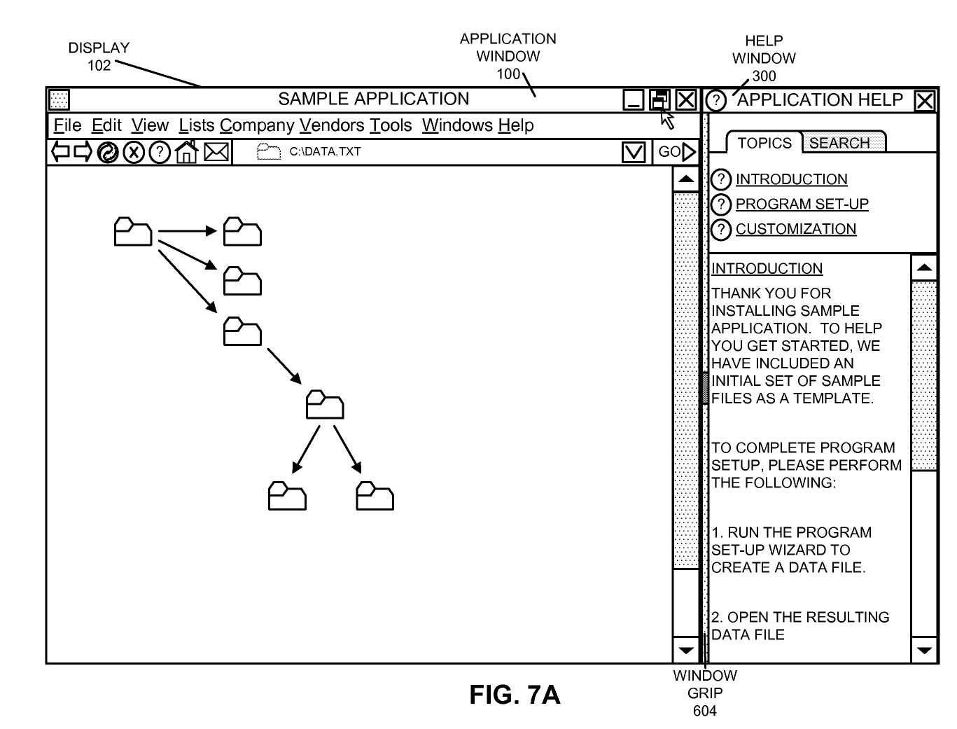

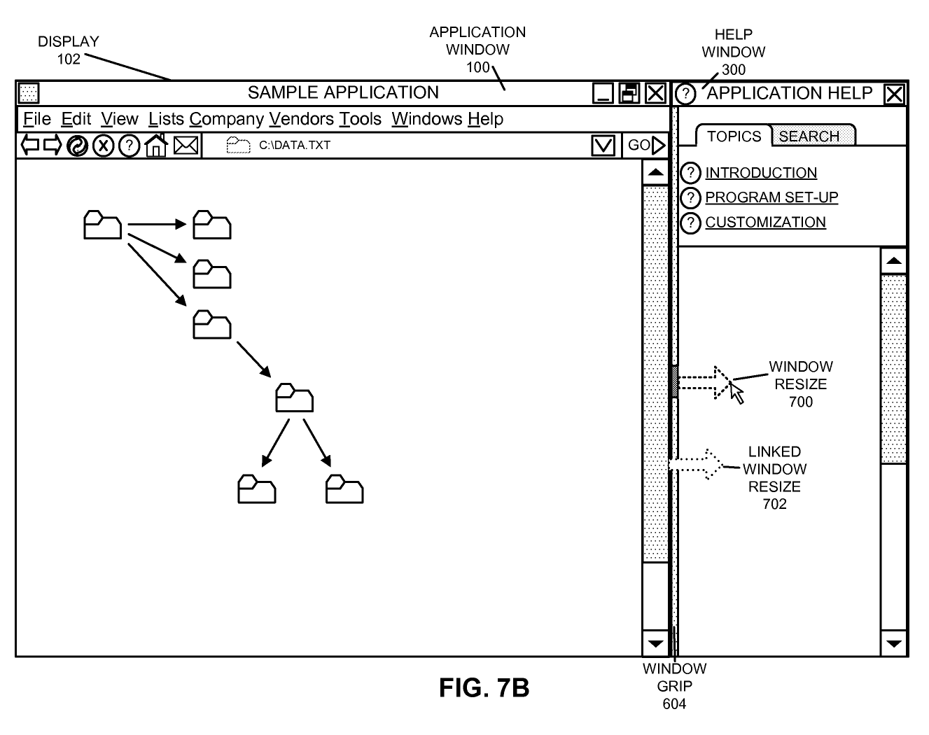

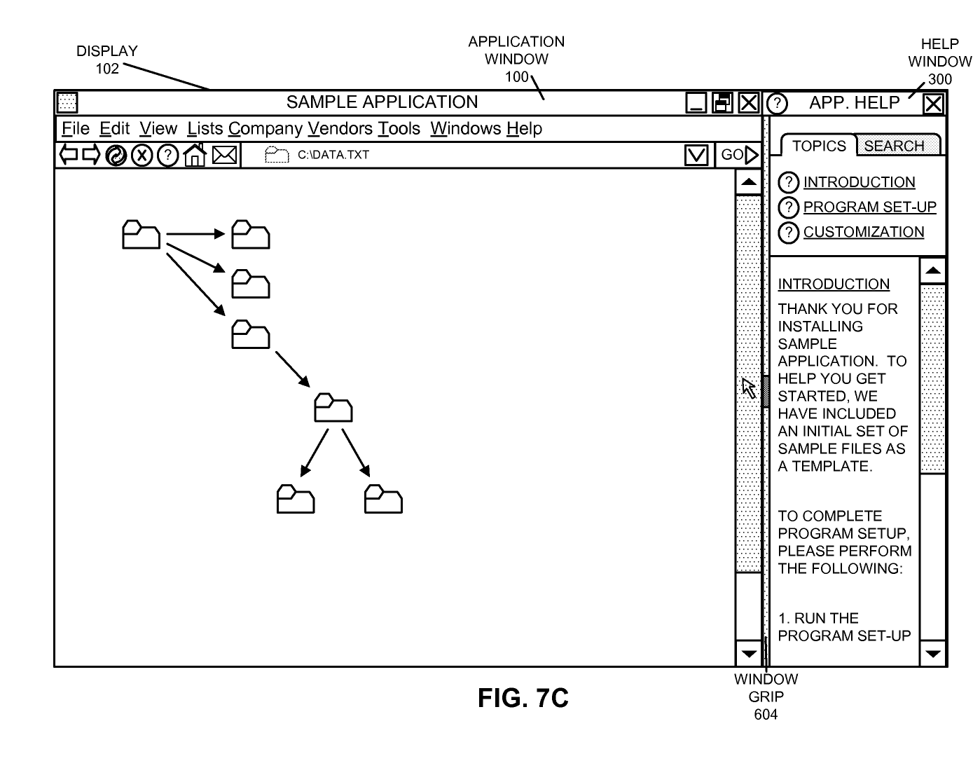

FIG. 7A illustrates the outcome of a modified maximize operation that maximizes the size of two linked windows, in contrast to a more typical maximize operation that maximizes the size of a single window. Operating systems typically request a set of application constraints from a given application when a window maximize request is received for that application. In some embodiments, the system can adjust the set of values returned to the operating system to leave open display space for a linked window, and then simultaneously resize the linked window into that available display space. Hence, in response to a maximize request for an application window (e.g. application window 100 in FIG. 3A), the system can specify values that result in an increase to the size of both the application window and a linked window. FIG. 7 illustrates the result of such an operation for the application window 100 and help window 300 of FIG. 3A, which have been maximized to share all available space in display 102. Note that if the user chooses to “restore” (e.g., un-maximize) the two windows, the system returns the windows to their original (smaller) size, but keeps them in proximity to one another. Similarly, if the two windows are minimized into an icon and then restored, they also return to their original side-by-side proximity.

Note also that a user can choose to perform the above-described alternate resize operation while the two windows are maximized, to re-proportion space between the maximized versions of the two windows. FIG. 7B illustrates a proportional resize operation that re-proportions space between two maximized linked windows. As described previously, a user can select the left border of help window 300 or the right border of application window 100 using the mouse cursor, and then move the mouse cursor left or right to re-proportion space between the two (maximized) windows. FIG. 7C illustrates the result of the window resize 700 and linked window resize 702 illustrated in FIG. 7B.

Note that a linked window may be opened using a variety of techniques, ranging from user-initiated actions (e.g. a mouse click on an icon or menu item or a keyboard shortcut) as well as system-initiated actions (e.g., the receipt of triggering data, a timer trigger, etc). Such techniques are generally known to those versed in the art, and hence are not described further in the instant application.

In one embodiment of the present invention, a blocked window and/or a modal window associated with the blocked window may send updates to a linked window. For instance, a “wizard” (e.g., a modal dialog that assists a user in performing a series of steps related to a larger application operation) may send updates to a linked help window to trigger the display of updated context information related to the current step in the larger application operation. Such a context-sensitive linked window can provide substantial benefit to users during long or complex modal operations.

In one embodiment of the present operation, a user can specify preferences for window settings and window options. For instance, the system may allow users to specify window size and/or layout preferences that are saved across window, application, and/or system sessions. Furthermore, the system may allow users to specify preferences relating to modal operations and/or window behavior during modal operations.

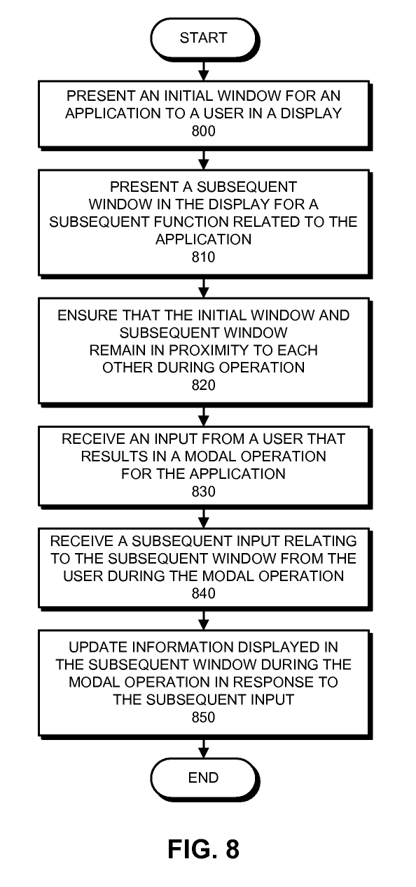

FIG. 8 presents a flow chart illustrating the process of facilitating information access during a modal operation. During operation, the system presents an initial window for an application to a user in a display (operation 800). Subsequently, the system presents a subsequent window in the display for a subsequent function related to the application (operation 810). The system ensures that the initial window and the subsequent window are presented, and remain, in proximity to each other during operation, even if user changes are applied to one or both windows (operation 820). At a later point, during operation, the system receives an input from a user that results in a modal operation for the application (operation 830). This modal operation restricts user changes to and/or user control of the initial window for the extent of the modal operation. However, the user can continue to access the subsequent window during the modal operation. Hence, when the system receives a subsequent input from the user during the modal operation that relates to the subsequent window (operation 840), the system can continue to update information displayed in the subsequent window in response to the subsequent input, despite the presence of the modal operation (operation 850).

In one embodiment of the present invention, the described techniques can be applied in a bi-directional manner. Both the initial window and any subsequent window can undergo modal operations, with the described techniques being used to allow subsequent access to the window not involved in the modal operation during the modal operation.

In summary, embodiments of the present invention facilitate information access during modal operations. The described techniques allow a tightly-integrated second window to in some ways function substantially similarly to an internal pane for an existing application window. However, by managing the windows separately (e.g., using separate processes), the system ensures that the second window remains immune from modal application states, and hence remains accessible to a user during modal operations that affect the existing application window. By keeping the second window in proximity to the existing application window over time and across user changes, the system emphasizes the link between the two windows while ensuring that they stay visible and do not interfere with one another during operation. Such functionality can provide substantial benefits to users, for instance by ensuring that users can always easily find and access help functionality.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. A method that facilitates accessing information during a modal operation, comprising:
presenting an initial window for an application to a user in a display;
presenting a subsequent window in the display for a subsequent function related to the application;
wherein the initial window and the subsequent window are presented in proximity to each other even if user changes are applied to one or both windows;
receiving an input from the user that results in the modal operation for the initial window, wherein the modal operation restricts user changes to and/or user control of the initial window during the modal operation;
receiving a subsequent input relating to the subsequent window from the user during the modal operation, wherein the user can continue to access the subsequent window during the modal operation; and
updating information displayed in the subsequent window during the modal operation in response to the subsequent input.

2. The method of claim 1, wherein the subsequent window provides help functionality for the application.

3. The method of claim 2, wherein presenting the subsequent window further involves presenting the subsequent window in response to a user request received during the modal operation.

4. The method of claim 2,
wherein presenting the initial window and the subsequent window in proximity presents an appearance that the subsequent window and the initial window are tightly-integrated; and
wherein the method facilitates providing help functionality for the application that remains accessible during the modal operation.

5. The method of claim 1,
wherein the initial window and the subsequent window are associated with separate operating system processes; and
wherein the separate operating system processes exchange window layout information and event notifications using inter-process communication techniques.

6. The method of claim 5, wherein the application governs control of window layout and window updates for both the initial window and the subsequent window.

7. The method of claim 1, wherein presenting the initial window and the subsequent window in proximity to each other even if user changes are applied to one or both windows involves user changes that include:
resizing one or both of the initial window and the subsequent window;
maximizing the size of the initial window and/or the subsequent window; and/or
minimizing and/or restoring the initial window and/or the subsequent window.

8. A computer-readable storage medium storing instructions that when executed by a computer cause the computer to perform a method that facilitates accessing information during a modal operation, the method comprising:
presenting an initial window for an application to a user in a display;
presenting a subsequent window in the display for a subsequent function related to the application;
wherein the initial window and the subsequent window are presented in proximity to each other even if user changes are applied to one or both windows;
receiving an input from the user that results in the modal operation for the initial window, wherein the modal operation restricts user changes to and/or user control of the initial window during the modal operation;
receiving a subsequent input relating to the subsequent window from the user during the modal operation, wherein the user can continue to access the subsequent window during the modal operation; and
updating information displayed in the subsequent window during the modal operation in response to the subsequent input.

9. The computer-readable storage medium of claim 8, wherein the subsequent window provides help functionality for the application.

10. The computer-readable storage medium of claim 9, wherein presenting the subsequent window further involves presenting the subsequent window in response to a user request received during the modal operation.

11. The computer-readable storage medium of claim 9,
wherein presenting the initial window and the subsequent window in proximity presents an appearance that the subsequent window and the initial window are tightly-integrated; and
wherein the method facilitates providing help functionality for the application that remains accessible during the modal operation.

12. The computer-readable storage medium of claim 8,
wherein the initial window and the subsequent window are associated with separate operating system processes; and
wherein the separate operating system processes exchange window layout information and event notifications using inter-process communication techniques.

13. The computer-readable storage medium of claim 12, wherein the application governs control of window layout and window updates for both the initial window and the subsequent window.

14. The computer-readable storage medium of claim 8, wherein presenting the initial window and the subsequent window in proximity to each other even if user changes are applied to one or both windows involves user changes that include:
resizing one or both of the initial window and the subsequent window;
maximizing the size of the initial window and/or the subsequent window; and/or
minimizing and/or restoring the initial window and/or the subsequent window.

15. An apparatus that facilitates accessing information during a modal operation, comprising:
a presentation mechanism configured to present an initial window for an application to a user in a display;
wherein the presentation mechanism is further configured to present a subsequent window in the display for a subsequent function related to the application;
wherein the initial window and the subsequent window are presented in proximity to each other even if user changes are applied to one or both windows;
a receiving mechanism configured to receive an input from the user that results in the modal operation for the application, wherein the modal operation restricts user changes to and/or user control of the initial window during the modal operation;
wherein the receiving mechanism is further configured to receive a subsequent input relating to the subsequent window from the user during the modal operation, wherein the user can continue to access the subsequent window during the modal operation for the application; and
an update mechanism configured to update information displayed in the subsequent window during the modal operation in response to the subsequent input.

16. The apparatus of claim 15, wherein the subsequent window provides help functionality for the application.

17. The apparatus of claim 16, wherein the presentation mechanism is further configured to present the subsequent window in response to a user request received during the modal operation.

18. The apparatus of claim 16,
wherein presenting the initial window and the subsequent window in proximity presents an appearance that the subsequent window and the initial window are tightly-integrated; and
wherein the apparatus facilitates providing help functionality for the application that remains accessible during the modal operation.

19. The apparatus of claim 15,
wherein the initial window and the subsequent window are associated with separate operating system processes; and
wherein the separate operating system processes exchange window layout information and event notifications using inter-process communication techniques.

20. The apparatus of claim 19, wherein the application governs control of window layout and window updates for both the initial window and the subsequent window.
